(19) United States
(12) Patent Application Publication
(10) Pub. No.: US 2005/0210660 A1
(43) Pub. Date: Sep. 29, 2005

(54) Method of fastening electrodes in a lithium-ion powered battery

(76) Inventor: Wenman Li, XinXiang (CN)

Correspondence Address: Kao H. Lu, 686 Lawson Ave., Havertown, PA, 19083, US

(21) Appl. No.: 10/809,304

(22) Filed: Mar. 24, 2004

(51) Int. Cl. H01M 2/24

(52) U.S. Cl. 29/623.1; 429/160

(57) ABSTRACT

The present invention provides a method of fastening leads to the positive and negative electrodes in large capacity, high power lithium-ion batteries, power lithium-ion batteries and power lithium-polymer batteries. This method uses rivets to fasten the leads (or terminals) to the positive and negative electrodes, which makes the connection secure and increases reliability.

### FIELD OF THE INVENTION

The present invention relates to methods of fastening leads (or terminals) to a battery, or more practically—fastening the leads to a positive electrode or a negative electrode (anodes and cathodes) of a lithium-ion battery or a lithium-polymer battery of a high power and large capacity.

### BACKGROUND OF THE INVENTION

The traditional fastening methods, such as bolting or ultrasonic welding, used to secure leads (or terminals) to the positive and the negative electrodes of a lithium-ion battery, have problems. When using a bolted method, the connections risk becoming loose if the battery is vibrated. The loose connection will increase the inner resistance between the lax contact points, and cause the battery to heat up during discharging, thus deteriorating the battery's performance. Furthermore, the loose connection may induce a sparks and potentially cause an explosion. On the other hand, the ultrasonic welding method is a much too complex and expensive process, and still produces unreliable welding in multi-plate welding. Therefore, there is a need to have a more cost effective, reliable method of fastening the leads to positive and negative electrodes of a lithium ion battery or a lithium-polymer battery of a high power and large capacity.

### SUMMARY OF THE INVENTION

One objective of this invention is to provide a reliable and cost-effective method of fastening metal leads (or terminals) to the positive and the negative electrodes of a battery. This will comprise of the following steps:
1. Stacking negative plates, separation membranes, and positive plates in alteration;
2. Aligning at least one multiple-plate positive current collector to all positive plates and at least one multiple-plate negative current collector to negative plates respectively, and then punching a hole in both collectors;
3. Fastening the positive current collector, the lead, and a first rivet together; and fasting the negative current collector, the lead, and a second rivet together, using riveting equipment; to form the connection between the leads and positive and negative electrodes; and
4. The number of rivets and points of riveting to be used may vary depending on the capacity of the battery.

### BRIEF DESCRIPTION OF THE DRAWING

FIG. 1 depicts the order in which the connection is riveted in power lithium-polymer battery.

FIG. 2 depicts the order in which the connection is riveted in large capacity, high power lithium-ion battery.

The present invention will become more apparent by referring to the following detailed description.

### DETAILED DESCRIPTION OF THE INVENTION

To overcome the weakness of these traditional connecting methods, the present invention uses rivets to fasten the leads (or terminals) to either the positive electrode or the negative electrode of a battery. In more detail, this invention uses a riveting equipment to fasten multi-plate current collectors, the leads and rivets together, to form a riveted, secure connection. In other words, multi-plate positive current collectors (anodes), the (positive) lead and a rivet are fastened together, while multi-plate negative current collectors (cathodes), the other (negative) lead and a rivet are fastened together. The cost-effective riveted connection will not become lose under constant vibration and it will increase reliability and will avoid using expensive equipment, ultimately reducing costs.

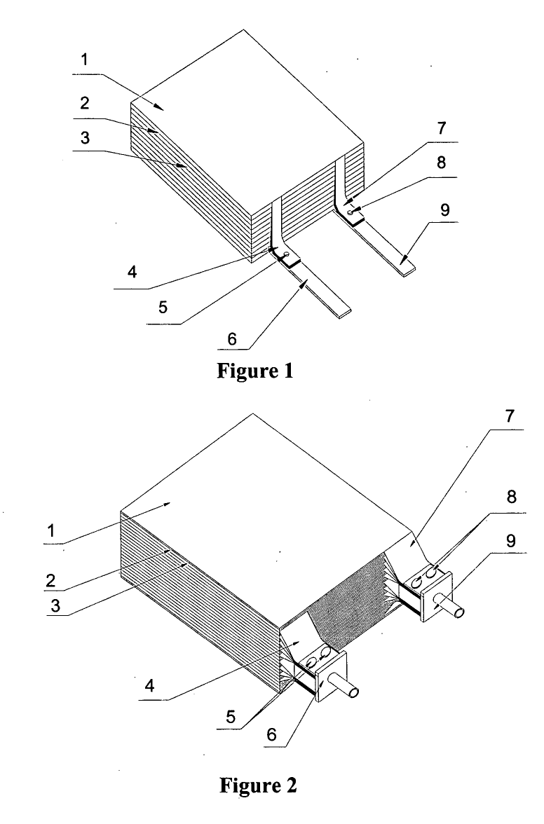

Referring to FIG. 1: First, this invention will stack a negative plate (1), a separation membrane (2) and a positive plate (3), and then stack a separation membrane (2), and a negative plate, in repeating sequences, until the desired number of stacks is reached. Second, the multi-plate positive current collectors (4) will be connected with these positive plates (3), while the invention aligns and connects the multi-plate negative current collectors (7) with all these negative plates (1), respectively. Thirdly, the invention will punch a hole in both collectors and the leads. It will use a rivet (5) to fasten the positive current collectors (4) and the lead (6) together through the punched hole. Using a similar method, this invention will use a rivet to fasten the negative current collectors (7) and the other lead (9) together through the punched hole. Using generically available riveting equipment can easily carry out this procedure. The number of rivets and points of riveting used may vary depending on the capacity of the battery.

FIG. 2 illustrates another example of fastening the leads with a battery using this invention. First the invention stacks a negative plate (1), a separation membrane (2), a positive plate (3), and another separation membrane (2), with the process being repeated. In FIG. 2, the positive current collector (4) can be the bonded extended ends of each of the positive plates. At least one hole is punched at the bonded ends, where a rivet is used to connect the positive plates and the lead (6). The similar method is used to connect the negative current collector (7) and the other lead (9) together. The number of rivets and the number of riveting points used in fastening a battery may vary, and depends on the capacity and the size of the battery.

1. A method of fastening the leads (or terminals) to positive (or anode) and negative (or cathode) electrodes, comprising the steps of:
Stacking negative plate, separation membrane and positive plate in alteration;
Aligning multi-plate positive current collector and multi-plate negative current collector respectively, then punch a hole in both collectors; and
Fastening the positive current collector, the lead and rivet together and the negative current collector, the lead and rivet together, using riveting equipment, to form the connection between the leads and positive and negative electrodes.

2. The method of fastening the leads to positive and negative electrodes of claim 1, wherein the number of rivets and points of riveting to be used may vary depending on the capacity of the battery.
